(19) United States
(12) Patent Application Publication
(10) Pub. No.: US 2016/0355121 A1
(43) Pub. Date: Dec. 8, 2016

(54) Cord Connector

(71) Applicant: Earl Gertsma, Berea, OH (US)

(72) Inventor: Earl Gertsma, Berea, OH (US)

(21) Appl. No.: 15/162,870

(22) Filed: May 24, 2016

Related U.S. Application Data
(63) Continuation-in-part of application No. 29/534,133, filed on Jul. 27, 2015.
Application No. 29/534,133 is a continuation-in-part of application No. 29/537,744, filed on Aug. 28, 2015, now Pat. No. D767373.
(60) Provisional application No. 62/170,421, filed on Jun. 3, 2015.
(60) Provisional application No. 62/173,027, filed on Jun. 9, 2015.

(51) Int. Cl. B60P 7/08; F16G 11/12

(52) U.S. Cl. CPC B60P 7/0846; F16G 11/12

(57) ABSTRACT

A cord connector and method of use that can be used to adjust the length of a bungee cord and/or to connect together multiple bungee cords.

The present invention claims priority to U.S. Provisional Application Ser. Nos. 62/170,421, filed on Jun. 3, 2015 and 62/173,027, filed Jun. 9, 2015; is a continuation-in-part of U.S. application Ser. No. 29/534,133 filed Jul. 27, 2015; and a continuation-in-part of U.S. application Ser. No. 29/537,744 filed Aug. 28, 2015, all of which are fully incorporated herein.

The present invention relates to a cord connector that can be used with cords to connect cords together and/or to reduce the length of a cord, and more particularly to a cord connector that can be used with bungee cords to connect one or more bungee cords together and/or to reduce the length of a bungee cord.

### BACKGROUND ON THE INVENTION

Bungee cords are available in a variety of lengths. In some cases, the length of the bungee cord is too long. In the past, one could tie a knot in the bungee cord to shorten the length of the bungee cord or purchase a shorter length bungee cord. In the past, if two or more bungee cords were used to create a desired longer length, the ends of the bungee cords typically were tied or knotted together. The tying or knotting of the bungee cords is inconvenient and the untying and unknotting of the bungee cord can further result in damage to bungee cord.

It would be desirable to provide a cord connector that can be convenient and easy to use to connect one or more bungee cords together and/or to reduce the length of a bungee cord.

### SUMMARY OF THE INVENTION

The present invention is directed to a cord connector that can be used to adjust the length of a bungee cord for use in various applications and/or to connect together two or more bungee cords. The cord connector of the present invention can also be used to connect different portions of a bungee cord such that the cord connector can enable the bungee cord to be tied about an object (e.g., tree, pole, post, etc.). The cord connector can thus be used to multiply the potential applications and uses of the bungee cord. Although the invention will be described with particular reference to bungee cords, it will be appreciated that the device of the present invention can be used with other types of cords (e.g., rope, yarn, string, etc.). The cord connector of the present invention can be used

In one non-limiting aspect of the present invention, there is provided a cord connector which can be used to adjust the length of a bungee cord. The cord connector of the present invention can be formed from a variety of different materials (e.g., plastic, reinforced plastic, wood, metal, ceramic, composite material, steel, stainless steel, aluminum, etc., or combinations thereof). The cord connector can be formed of single piece of material; however, this is not required. The cord connector can be formed in a one-piece constriction; however, this is not required. The cord connector can be manufactured by a variety of processes (e.g., metal stamping, molding, laser cutting, mechanical cutting, extrusion, punch press, etc.). The size, shape, configuration and materials of the cord connector are non-limiting. The cord connector can be symmetrical along one or more axes; however, this is not required.

In another and/or alternative non-limiting aspect of the present invention, there is provided a cord connector having a generally planar top surface and bottom surface, first and second side edges, and first and second end edges; however, this is not required. The shape of the cord connector of the present invention is non-limiting (e.g., square, rectangular, oval, circular, square, polygonal, etc.). One or more of the edges can be linear or non-linear. In one non-limiting configuration, the first and second end edges are non-linear; however, this is not required. The non-linear edges (when used) can have a semicircular shape; however, other or alternative shapes can be used. The semicircular shape (when used) typically has a radius of about 0.1-2 inch, typically 0.2-1 inch, and more typically from about 0.2-0.8 inches; however, this is not required. The side of the curved edge of the device can be increased and/or decreased proportionately with the size of the cord connector; however, this is not required. The thickness, length, and/or width of the cord connector can be generally constant along the longitudinal length of the device; however, this is not required. The dimensions of the cord connector are non-limiting. In one non-limiting configuration, the cord connector is about 0.5-6 inches long, 0.2-3 inches wide, and 0.05-0.5 inches thick; however, other dimensions can be used. In another and/or alternative non-limiting configuration, the cord connector is formed of single piece of material, such as a metal material or plastic material, and is about 1-4 inches long, 0.5-1.5 inches wide, and 0.05-0.25 inches thick; however, other dimensions can be used.

In another and/or alternative non-limiting aspect of the present invention, the cord connector includes one or more slots. The one or more slots can be configured to receive a portion of a bungee cord. The one or more slots are positionable 1) at an edge of the body of the cord connector, and/or 2) through a center portion of the cord connector, wherein the center portion is spaced from the edge of the body of the cord connector. In one non-limiting configuration, the cord connector includes a slot on each side edge; however, this is not required. As can be appreciated, one or more side edges of the cord connector can include more than one slot. As can also be appreciated, one side edge of the cord connector can have a different number of slots than the other side edge of the cord connector; however, this is not required. In another and/or alternative non-limiting configuration, the cord connector includes one or more slots spaced apart from the edge of the cord connector; however, this is not required. As can be appreciated, one side of the cord connector can include one or more slots and the other side of the cord connector can include no slots. As can also be appreciated, the cord connector can be twisted along its longitudinal length (e.g., 45-270°, etc.) such that one or more slots can appear to be on one side of the cord connector even though such slots are positioned on different sides of the cord connector. In another and/or alternative non-limiting configuration, the ends of the cord connector do not include slots; however, this is not required. The size and shape of the one or more slots are non-limiting. The orientation of the one or more slots is non-limiting. In one non-limiting configuration where two slots are used, the two slots can extend in opposite directions; however, this is not required. As such, the cord connector can have a substantially E-shape. As can be appreciated, other shaped structures can be used (e.g., C-shaped, Z-shaped, S-shaped, O-shaped, etc.). The distance that each of the one or more slots extends into the body of the cord connector is non-limiting. Generally, the one or more slots extend about 20-80% into the width or length of body of the cord connector; however, this is not required. The one or more slots (when used) can have generally the same shape; however, this is not required. In one non-limiting configuration, the one or more slots have a general V-shape; however, other alternative slot shapes can be used (e.g., rectangular, square, diamond, polygonal, etc.).

In another and/or alternative non-limiting aspect of the present invention, the one or more slots can be tapered such that the width of the slot progressively decreases from the open end of the slot to the closed end of the slot; however, this is not required. The progressive decrease in size of the one or more slots can be uniform or non-uniform along the length of the slot; however, this is not required. One non-limiting advantage of using a V-shaped, tapering configuration in the one or more slots is that the bungee cord can become increasingly secured to the slots as tension on the bungee cord is increased. As such, the V-shaped, tapering slots can hold the bungee cord and secure the bungee cord in place to prevent the bungee cord from coming loose from the cord connector during operation. The closed end of the one or more slots is not limited in shape. In one non-limiting configuration, the closed end of the one or more slots are curved so as to maximize the engagement between an outer circumference of the bungee cord and the closed end of the one or more slots; however, this is not required. As can be appreciated, the closed end of the one or more slots can be square, pointed, polygonal, etc.

In another and/or alternative non-limiting aspect of the present invention, the one or more slots can include a multi-angle taper. In such a configuration, the width of the one or more slots can become increasingly smaller towards the closed end at a first angle, and then increasingly smaller towards the closed end at a second angle; however, this is not required. In one non-limiting configuration, the opening of the one or more slots typically has a first angle of about 5-80°, more typically a first angle of about 10-30°, and still more typically a first angle of about 15-20°. In another and/or alternative non-limiting configuration, the opening of the one or more slots typically have a second angle of about 1-60°, more typically a second angle of about 2-30°, and still more typically a second angle of about 5-10°. In one specific configuration, the angle of the opening of the first slot is about 17°, and the angle of the opening of the second slot is about 6°; however, this is not required.

In another and/or alternative non-limiting aspect of the present invention, the edges of the body of the cord connector and/or the edges of the one or more slots are configured to be rounded so as to prevent cutting into the bungee cord during operation; however, this is not required. In another and/or alternative non-limiting aspect of the present invention, the edges of the body of the cord connector and/or the edges of the one or more slots are serrated for the purpose of increasing engagement between the bungee cord and the bungee cord connector; however, this is not required.

In another and/or alternative non-limiting aspect of the present invention, the one or more slots on the cord connector are angled relative to the first and/or second side edges of the cord connector; however, this is not required. As can be appreciated, the one or more slots can be perpendicular to the first and/or second side edges of the cord connector; however, this is not required. In one non-limiting configuration, the one or more slots are typically angled from about 10-80° relative to a side edge, more typically from about 20-70° relative to a side edge, and still more typically from about 40-70° relative to a side edge of the cord connector. In one specific configuration, the one or more slots are angled from about 55-65° relative to a side edge of the body of the cord connector; however, this is not required.

In another and/or alternative non-limiting aspect of the present invention, the cord connector includes one or more apertures and/or openings, wherein the one or more apertures and/or openings are spaced from the peripheral edge of the body of the cord connector. The one or more apertures and/or openings can be used as hanging holes or apertures for the purpose of facilitating the hanging of the cord connector on a hook, post, etc. The one or more apertures and/or openings can be spaced apart from the one or more slots; however, this is not required. As can be appreciated, the one or more apertures and/or openings can be continuous with the one or more slots. The size, shape, and configuration of the one or more openings are non-limiting. As can be appreciated, the size, shape, and configuration of the one or more apertures and/or openings can be configured to facilitate various types and sizes of ropes, cords, tethers, bungee cords, etc. In one non-limiting configuration, the cord connector includes first and second openings, wherein the first opening is positionable at or near a first edge of the cord connector, and the second opening positionable at or near a second edge of the cord connector; however, this is not required. In another and/or alternative non-limiting configuration, the cord connector includes first and second peripheral openings, and a central opening, wherein the central opening is positionable between the first and second peripheral openings. In such a configuration, the central opening can form the opening of one or more slots as described above for the purpose of receiving a portion of a bungee cord; however, this is not required.

In one method of operation, the cord connector of the present invention can be used to reduce the length of a bungee cord. Typically, a first portion of a bungee cord can be releasably secured to a first slot of the cord connector and a second portion of the bungee cord can be releasably secured to a second slot of said cord connector. The excess length of the bungee cord (i.e., the length of bungee cord that is not required for the particular application) forms a loop between the first and second slots of the cord connector; however, this is not required. As such, the length of a bungee cord can be easily and conveniently adjusted for a particular application by use of the cord connector of the present invention. Once the use of the cord connector is completed, the bungee cord can be simply removed from the slots in the cord connector.

In another and/or alternative method of operation, the cord connector of the present invention can also be used to secure one or both ends of a bungee cord to the cord connector. In some applications, one or both ends of the bungee cord are looped about an object. The cord connector of the present invention can be used to secure one or both ends of the bungee cord during such applications. As can be appreciated, the cord connector of the present invention can be used in other or additional applications with a bungee cord.

In yet another and/or alternative method of operation, a first method of using the cord connector in accordance with the present invention to adjust the length of a bungee cord can comprise the steps of 1) passing a first portion of a bungee cord through a hook portion and into an open end of a first slot, 2) seating the first portion of the bungee cord at least partially in the closed end of the first slot, 3) passing a second portion of the bungee cord through a hook portion and into the open end of a second slot, 4) seating the second portion of the bungee cord at least partially in the closed end of the second slot, thereby providing a loop portion in the bungee cord (i.e., the length of the bungee cord not needed for an application), and 5) pulling the first and/or second portions of the bungee cord such that the first portion of the bungee cord passes further through the first slot and the second portion of the bungee cord passes further through the second slot. As such, the cord connector can be used to take up slack in a bungee cord, thereby adjusting the length of the bungee cord.

In still yet another and/or alternative method of operation, a method of using the cord connector in accordance with the present invention to adjust the length of a cord (e.g., rope, tether, string, yarn, fishing line, straps, bungee cord, etc.) can comprise the steps of 1) inserting a first end of a cord through a first peripheral opening from the bottom surface of the cord connector, 2) inserting the end of the cord through a second peripheral opening from the top surface of the cord connector such that a looped portion of the cord (i.e., the length of the cord not needed for an application) is provided on the top surface of cord connector between the first and second peripheral openings, 3) passing the looped portion of the cord through a hook of the central opening, 4) seating a first portion of said looped portion of said cord in the closed end of a first slot, 5) seating a second portion of said looped portion of the cord in the closed end of a second slot, and 6) pulling the cord further through the first and second slots so as to take up slack in the cord, thereby adjusting the length of the cord.

One non-limiting object of the present invention is the provision of a cord connector which can be used in conjunction with various types of cords.

Another and/or alternative non-limiting object of the present invention is the provision of a cord connector which can be used to easily and conveniently adjust the length of a bungee cord for a particular application.

Another and/or alternative non-limiting object of the present invention is the provision of a cord connector having a main body including or more slots positionable on the main body of the cord connector.

Another and/or alternative non-limiting object of the present invention is the provision of a cord connector including one or more slots wherein the one or more slots are configured to secure a cord in the slot, thereby preventing the cord from slipping loose through the slot during use.

Another and/or alternative non-limiting object of the present invention is the provision of a cord connector wherein the edges of the cord connector are rounded so as to prevent cutting or other types of damage to the cord during use.

Another and/or alternative non-limiting object of the present invention is the provision of a cord connector that is configured to enable a user to easily and conveniently remove a cord from the cord connector after use of the cord connector is completed.

Another and/or alternative non-limiting object of the present invention is the provision of a handheld cord connector which does not need to be permanently attached to an object of structure.

These and other objects and advantages will become apparent from the following description taken together with the accompanying drawings.

### BRIEF DESCRIPTION OF THE DRAWINGS

Reference may now be made to the drawings, which illustrate various embodiments that the invention may take in physical form and in certain parts and arrangements of parts wherein:

FIG. 1 is a top plan view of one non-limiting cord connector in accordance with the present invention;

FIG. 2 is an elevation perspective view of the cord connector as illustrated in FIG. 1;

FIG. 3 is a top plan view of another non-limiting cord connector in accordance with the present invention;

FIG. 4 is an elevation perspective view of the cord connector as illustrated in FIG. 3;

FIG. 5 is a top plan view of another non-limiting cord connector in accordance with the present invention;

FIG. 6 is an elevation perspective view of the cord connector as illustrated in FIG. 5;

FIG. 7 is a top plan view of another non-limiting cord connector in accordance with the present invention;

FIG. 8 is an elevation perspective view of the cord connector as illustrated in FIG. 7;

FIG. 9 is a top plan view of another non-limiting cord connector in accordance with the present invention;

FIG. 10 is an elevation perspective view of the cord connector as illustrated in FIG. 9;

FIG. 11 is a top plan view of another non-limiting cord connector in accordance with the present invention;

FIG. 12 is an elevation perspective view of the cord connector as illustrated in FIG. 11;

FIG. 13 is a top plan view of another non-limiting cord connector in accordance with the present invention;

FIG. 14 is an elevation perspective view of the cord connector as illustrated in FIG. 13;

FIG. 15 is a top plan view of another non-limiting cord connector in accordance with the present invention;

FIG. 16 is an elevation perspective view of the cord connector as illustrated in FIG. 15;

FIG. 17 is a top plan view of another non-limiting cord connector in accordance with the present invention;

FIG. 18 is an elevation perspective view of the cord connector as illustrated in FIG. 17;

FIG. 19 is a top plan view of another non-limiting cord connector in accordance with the present invention; and,

FIG. 20 is an elevation perspective view of the cord connector as illustrated in FIG. 19.

### DETAILED DESCRIPTION OF NON-LIMITING EMBODIMENTS

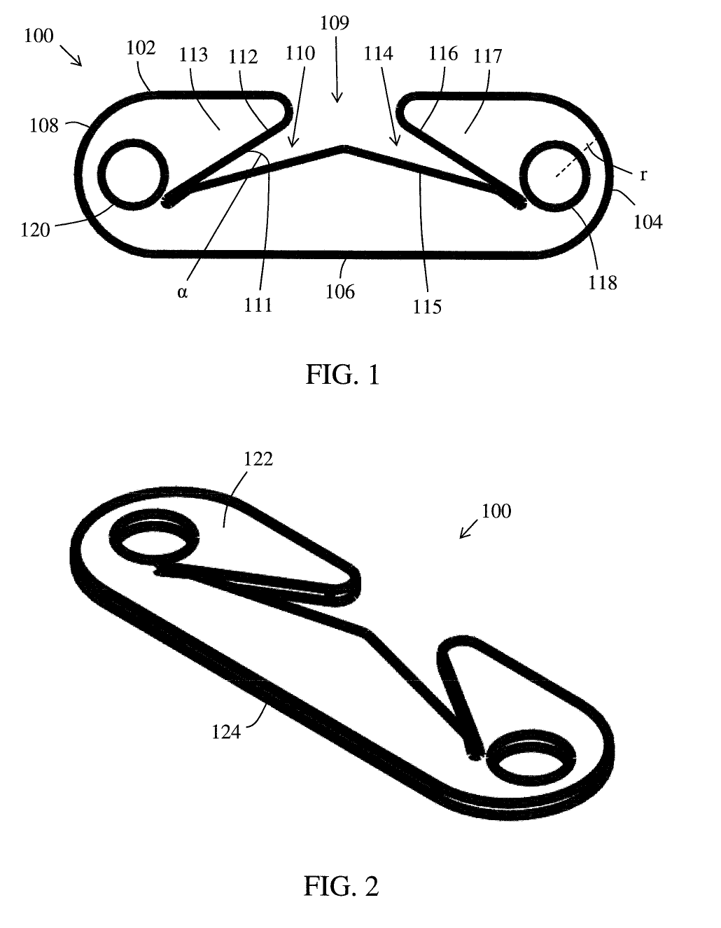

Referring now to the drawings, wherein the showings are for the purpose of illustrating at least one non-limiting embodiment of the invention only and not for the purpose of limiting the invention, FIGS. 1-20 illustrate various non-limiting cord connectors in accordance with the present invention.

In the various non-limiting embodiments, the cord connector includes a generally oblong-shaped body having first and second end edges and first and second side edges, and one or more slots. The first and second side edges are generally parallel with one another along about 30-100% of the longitudinal length of the side edges (and all values and ranges therebetween), and typically are generally parallel with one another along about 60-100% of the longitudinal length of the side edges. The type of bungee cord used in conjunction with the cord connector of the present invention is non-limiting. For example, the cord connector of the present invention can be used with standard half-inch diameter bungee cords; however, other or alternative size bungee cords can be used. Although the cord connector is described for use with bungee cords, it will be appreciated that the cord connector can be used with other types of cords.

Referring now to FIGS. 1-2, there is illustrated a cord connector 100 having a generally oblong-shaped body having a top surface 122 and a bottom surface 124. The cord connector is also illustrated as having a first side edge 102, a second side edge 106, a first end edge 104, and a second end edge 108. As illustrated in FIGS. 1-2, first and second end edges 104, 108 are curved in a continuously arcuate shape of radius r between first and second side edges 102, 106. Cord connector 100 includes a first and second peripheral opening 118, 120. Peripheral opening 118 is illustrated as having a circular shape and being positioned at or near first end edge 104. Peripheral opening 120 is illustrated as having a circular shape and being positioned at or near second end edge 108. Cord connector 100 also includes a central opening 109 positionable along side edge 102. The first and second side edges are illustrated as being generally parallel to one another. The two end edges have the same shape, size and radius of curvature. The two peripheral openings are spaced from the edges of the cord connector and have the same size and shape. The thickness of the body of the cord connector is generally uniform. The body of the cord connector is formed of a durable material such as metal, wood or plastic.

Cord connector 100 is illustrated in FIGS. 1-2 as including two slots 110 and 114. The open end of slots 110, 114 are illustrated as being provided on the same side of the cord connector such that the opening of slot 110 faces the opening of slot 114. Slot 110 is illustrated as being positioned from edge 108 a distance about equal to the distance as slot 114 is positioned from end edge 104. The open end of slot 110 can be the same as the open end of slot 114, thereby defining the central opening 109 along side edge 102. As such, slots 110, 114 can extend as slots from central opening 109 on side edge 102; however, this is not required. The slots are generally V-shaped and have generally the same size and shape. The angle α formed by the two sides of each of the slots is illustrated as being generally the same and is about 10-50°, and more typically about 15-40°. The end of the each of the slots is illustrated as having the sides being generally parallel to one another; however, this is not required. Generally about 60-100% of the depth of the each slot has a tapered portion. As illustrated in FIGS. 1-2, about 60-90% of each of the slots has a tapered portion and the remainder has the sides being generally parallel to one another. The back end of the slot is generally rounded; however, this is not required. The back end of each slot is spaced inwardly from the peripheral edge of the body.

As illustrated in FIGS. 1-2, slots 110, 114 extend in opposite directions from the central opening 109 into the body of cord connector 100 at an angle from side edge 102. In such a configuration, the closed end of slot 110 is positioned at or near peripheral opening 120, and the closed end of slot 114 is positioned at or near peripheral opening 118. Edge 111 of slot 110 is illustrated as non-parallel with side edge 106 and can slope upwardly relative to side edge 106 at an angled of about 5°-25°, more typically about 10°-15°; however, this is not required. The cord connector 100 is illustrated in FIGS. 1-2 as being symmetrical. As such, slot 114 can be angled from side edge 106 of cord connector 100 at a similar angle as slot 110; however, this is not required. As can be appreciated, the angles of slots 110 and 114 relative to side edge 106 can be different.

Edge 112 of slot 110 and edge 102 of the body of cord connector 100 define a hook portion 113 on the body of cord connector 100. Similarly, edge 116 of slot 114 and edge 102 of the body of cord connector 100 define a hook portion 117 on the body of cord connector 100. Hook portions 113, 117 are configured to facilitate insertion of a bungee cord into slots 110, 114, respectively. The end of hook portions 113, 117 are illustrated as being rounded for the purpose of facilitating entrance and/or exit of a bungee cord from slots 110, 114; however, this is not required. With continued reference to FIGS. 1-2, openings 118, 120 are spaced from slots 110, 114.

In use, when a single bungee cord is to be reduced in length, one portion of the bungee cord is positioned in one slot and another portion of the bungee cord is inserted into the other slot of the cord connector. The shape and size of the slots inhibits or prevents slippage of the bungee cord that is secured in the slots. The looped portion of the bungee cord between the two slot results in the reduced length of the bungee cord. After the use of the bungee cord is completed, the portions of the bungee cord are simply removed from the slots. When two bungee cords are to be connected together, one portion of the first bungee cord is connected to one of the slots in the cord connector and one portion of the second bungee cord is connected to the other slot of the cord connected, thereby resulting in the connecting together of the two bungee cords. After the use of the two bungee cords is completed, the portions of the two bungee cords connected to the cord connector are simply removed from the slots.

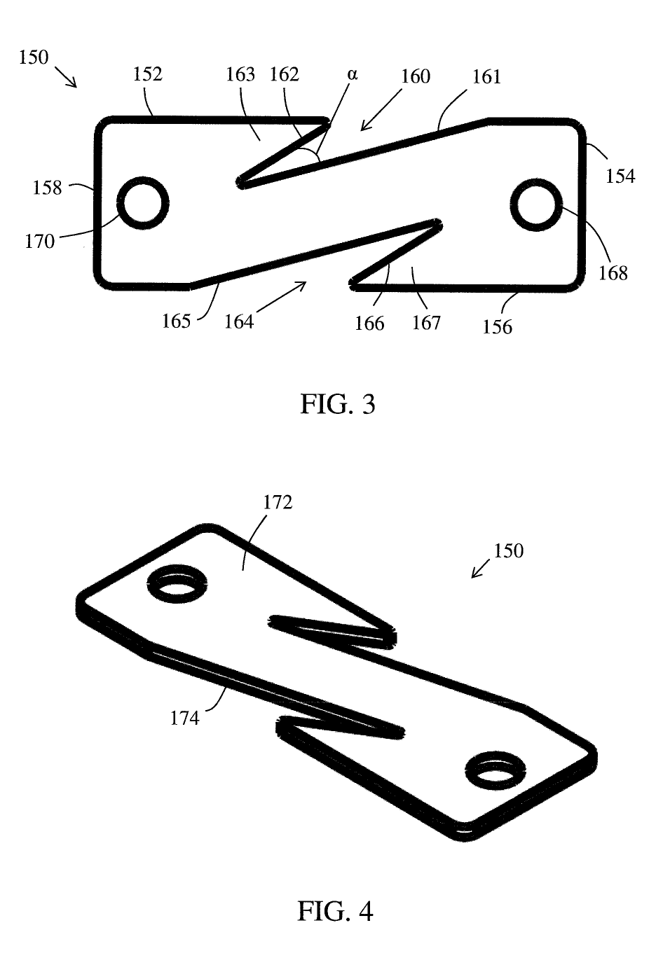

Referring now to FIGS. 3-4, there is illustrated a cord connector 150 having a generally rectangular-shaped body having a top surface 172 and a bottom surface 174. The cord connector is also illustrated as having a first side edge 152, a second side edge 156, a first end edge 154, and a second end edge 158. The cord connector 150 includes first and second opening 168, 170. Opening 168 is illustrated as having a circular shape and being positioned at or near first end edge 154. Opening 170 is illustrated as having a circular shape and being positioned at or near second end edge 158 of cord connector 150. The first and second side edges are illustrated as being generally parallel to one another and the two end edges are also illustrated as being generally parallel to one another. The two peripheral openings are spaced from the edges of the cord connector and have the same size and shape. The thickness of the body of the cord connector is generally uniform. The body of the cord connector is formed of a durable material such as metal, wood or plastic.

Cord connector 150 is illustrated in FIGS. 3-4 as including two slots 160, 164. The open ends of slots 160, 164 are provided on opposite sides of the cord connector, slot 160 being positioned from end edge 154 a distance about equal to the distance as slot 164 is positioned from end edge 158.

As illustrated in FIGS. 3-4, slots 160, 164 extend in opposite directions into the body of cord connector 150 at an angle from side edges 152, 156, respectively. In such a configuration, the closed end of slot 160 is positioned at or near end edge 158, and the closed end of slot 164 is positioned at or near end edge 154 of cord connector 150. As illustrated in FIGS. 3-4, edge 161 of slot 160 is substantially parallel to edge 165 of slot 164 and overlap one another, and edge 162 of slot 160 is substantially parallel to edge 166 of slot 164 and do not overlap one another; however, this is not required. In such a configuration, the cord connector is illustrated as being substantially Z-shaped or S-shaped. The back or closed ends of slots 160, 162 are illustrated as being rounded or pointed; however, this is not required. The slots are generally V-shaped and have generally the same size and shape. The angle α formed by the two sides of each of the slots is illustrated as being generally the same and is about 10-30°, and more typically about 10-15°. Generally, about 60-100% of the depth of the each slot has a tapered portion. The back end of each slot is spaced inwardly from the peripheral edge of the body.

Edge 162 of slot 160 and edge 152 of the body of cord connector 150 define a hook portion 163 on the body of cord connector 150. Similarly, edge 166 of slot 164 and edge 156 of the body of cord connector 150 define a hook portion 167 on the body of cord connector 150. Hook portions 163, 167 are configured to facilitate in the insertion of a bungee cord into slots 160, 164, respectively. The end of hook portions 163, 167 can be curved so as to prevent damage to the bungee cord as said bungee cord is passed between hook portions 163, 167 and through the open end of slots 160, 164. With continued reference to FIGS. 3-4, openings 168, 170 are spaced from slots 160, 164.

In use, when a single bungee cord is to be reduced in length, one portion of the bungee cord is positioned in one slot and another portion of the bungee cord is inserted into the other slot of the cord connector. The shape and size of the slots inhibits or prevents slippage of the bungee cord that is secured in the slots. The looped portion of the bungee cord between the two slot results in the reduced length of the bungee cord. After the use of the reduced bungee cord is completed, the portions of the bungee cord are simply removed from the slots. When two bungee cords are to be connected together, one portion of the first bungee cord is connected to one of the slots in the cord connector and one portion of the second bungee cord is connected to the other slot of the cord connected, thereby resulting in the connecting together of the two bungee cords. After the use of the two connected bungee cords is completed, the portions of the two bungee cords connected to the cord connector are simply removed from the slots.

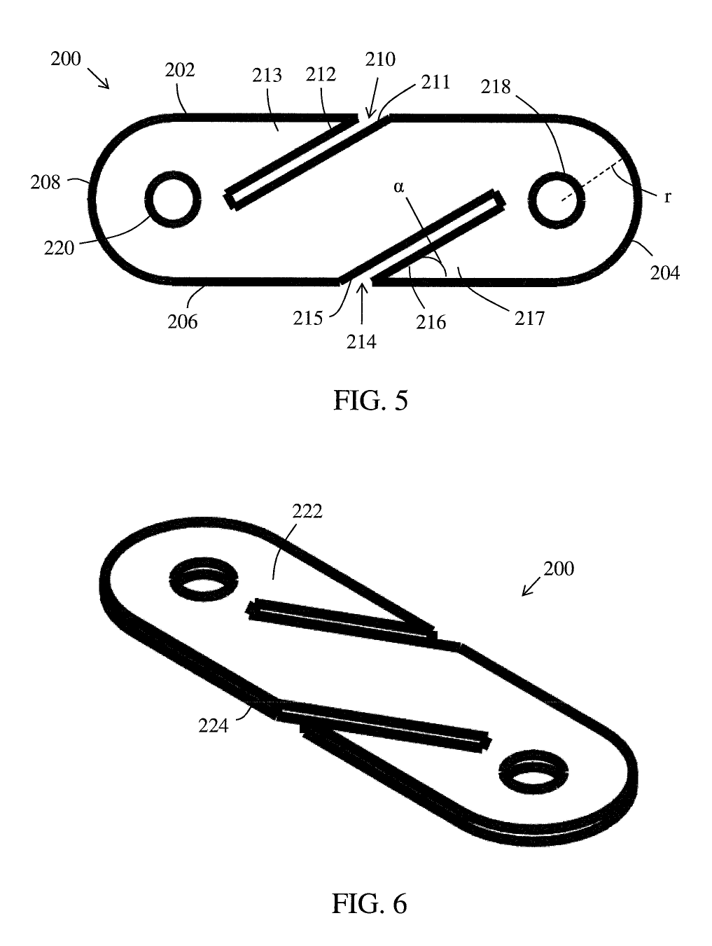

Referring now to FIGS. 5-6, there is illustrated a cord connector 200 having a generally oblong-shaped body having a top surface 222 and a bottom surface 224. The cord connector is also illustrated as having a first side edge 202, a second side edge 206, a first end edge 204, and a second end edge 208. As illustrated in FIGS. 5-6, first and second end edges 204, 208 are curved in a continuously arcuate shape of radius r between first and second side edges 204, 208. The cord connector 200 includes a first and second opening 218, 220. Opening 218 is illustrated as having a circular shape and being positioned at or near first end edge 204. Opening 220 is illustrated as having a circular shape and being positioned at or near second end edge 208. The first and second side edges are illustrated as being generally parallel to one another. The two end edges have the same shape, size and radius of curvature. The two peripheral openings are spaced from the edges of the cord connector and have the same size and shape. The thickness of the body of the cord connector is generally uniform. The body of the cord connector is formed of a durable material such as metal, wood or plastic.

Cord connector 200 is illustrated in FIGS. 5-6 as including two slots 210, 212. The open end of slots 210, 212 are provided on opposite sides of the cord connector, slot 210 being positioned from end edge 204 a distance about equal to the distance as slot 212 is positioned from end edge 208.

As illustrated in FIGS. 5-6, slots 210, 214 extend in opposite directions into the body of cord connector 200 at an angle from side edges 202, 206, respectively. In such a configuration, the closed end of slot 210 is positioned at or near end edge 208, and the closed end of slot 214 is positioned at or near end edge 204 of cord connector 200. As illustrated in FIGS. 5-6, edge 211 of slot 210 is substantially parallel to edge 215 of slot 214 and overlap one another, and edge 212 of slot 210 is substantially parallel to edge 216 of slot 214 and do not overlap one another; however, this is not required. In such a configuration, the cord connector is illustrated as being substantially Z-shaped or S-shaped. The back or closed ends of slots 160, 162 are illustrated as being flat or rounded; however, this is not required. The width of the slots is illustrated as being generally constant wherein the two sides of each slot are generally parallel to one another, and the two slots have generally the same size and shape. Each of the slots angles into the body of the cord connector at an angle that is non-perpendicular to the sides of the body of the cord connector. The angle α formed by edge 212 of slot 210 relative to side edge 202, and by edge 216 of slot 214 relative to side edge 206 are generally the same and are about 10-80°, and more typically about 20-45°. The back end of each slot is spaced inwardly from the peripheral edge of the body.

Edge 212 of slot 210 and edge 202 of the body of cord connector 200 define a hook portion 213 on the body of cord connector 200. Similarly, edge 216 of slot 214 and edge 206 of the body of cord connector 200 define a hook portion 217 on the body of cord connector 200. Hook portions 213, 217 are configured to facilitate insertion of a bungee cord into slots 210, 214, respectively. The end of hook portions 213, 217 are illustrated as being pointed so as to minimize the space for entry and/or exit at the open end of slots 160, 164; however, the ends can be rounded.

In use, when a single bungee cord is to be reduced in length, one portion of the bungee cord is positioned in one slot and another portion of the bungee cord is inserted into the other slot of the cord connector. The shape and size of the slots inhibits or prevents slippage of the bungee cord that is secured in the slots. The looped portion of the bungee cord between the two slots results in the reduced length of the bungee cord. After the use of the reduced bungee cord is completed, the portions of the bungee cord are simply removed from the slots. When two bungee cords are to be connected together, one portion of the first bungee cord is connected to one of the slots in the cord connector and one portion of the second bungee cord is connected to the other slot of the cord connected thereby resulting in the connecting together of the two bungee cords. After the use of the two connected bungee cords is completed, the portions of the two bungee cords connected to the cord connector are simply removed from the slots.

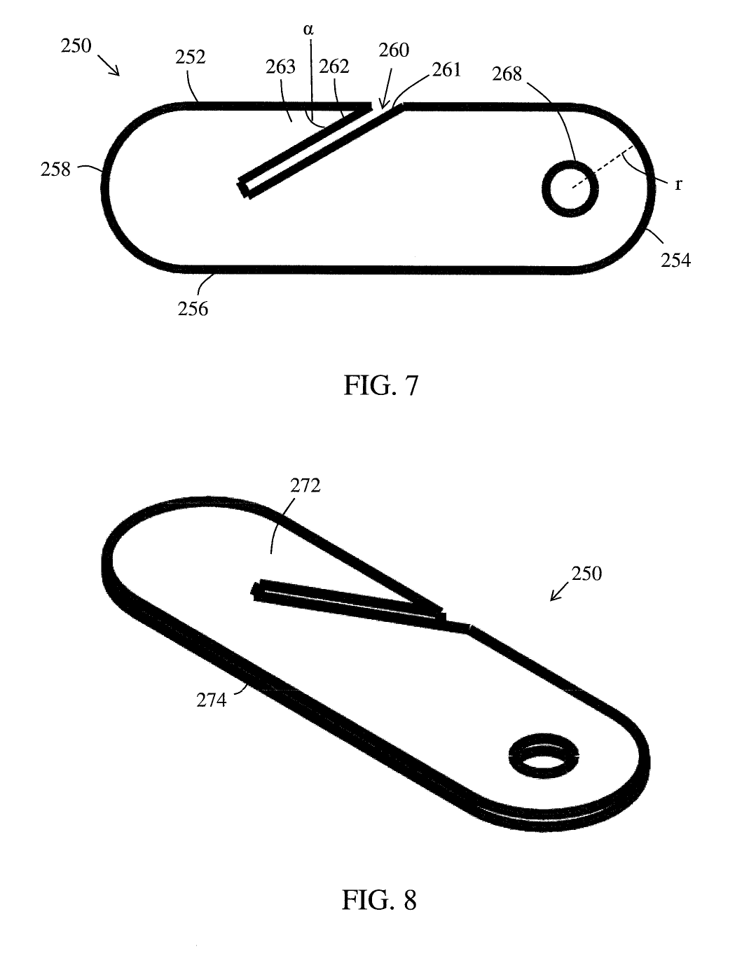

Referring now to FIGS. 7-8, there is illustrated a cord connector 250 having a generally oblong-shaped body having a top surface 272 and a bottom surface 274. The cord connector is also illustrated as having a first side edge 252, a second side edge 256, a first end edge 254, and a second end edge 258. As illustrated in FIGS. 7-8, first and second end edges, 254, 258 are curved in a continuously arcuate shape of radius r between first and second side edges 252, 256. The cord connector 250 includes an opening 268. Opening 268 is illustrated as having a circular shape and being positioned at or near first end edge 254. The first and second side edges are illustrated as being generally parallel to one another. The two end edges have the same shape, size and radius of curvature. The peripheral opening is spaced from the edge of the cord connector. The thickness of the body of the cord connector is generally uniform. The body of the cord connector is formed of a durable material such as metal, wood or plastic.

Cord connector 250 is illustrated as including a slot 260. The open end of slot 260 is provided on side edge 252 of the cord connector, slot 260 being positioned at or near a midpoint along side edge 252 of cord connector 250. As illustrated in FIGS. 7-8, slot 260 extends at an angle from side edge 252. In such a configuration, the closed end of slot 260 is positioned at or near end edge 258 of cord connector 250. The back or closed end of slot 260 is illustrated as being flat or rounded; however, this is not required. The width of the slot is illustrated as being generally constant wherein the two side of each slot are generally parallel to one another. The slot angle into the body of the cord connector is at an angle that is non-perpendicular to the side of the body of the cord connector. The angle α formed by edge 262 of slot 260 relative to side edge 252 is about 10-80°, and more typically about 20-45°.

Edge 262 of slot 260 and edge 252 of the body of cord connector 250 define a hook portion 263 on the body of cord connector 250. Hook portion 263 is designed to facilitate insertion of a bungee cord into slot 260. The end of hook portion 263 is illustrated as being pointed; however, this is not required. The opening of slot 260 is positioned ±20%, typically ±10%, and more typically ±5% of the midpoint of side edge 252 along the longitudinal length of side edge 252; however, this is not required. The end of slot 260 is positioned at a further distance from opening 268 than the open end of slot 260 at side edge 252; however, this is not required. The back end of the slot is spaced inwardly from the peripheral edge of the body.

In use, when a single bungee cord is to be connected to the cord connector, one portion of the bungee cord is connected to the slot in the cord connector. After the use of the bungee cord is completed, the portion of the bungee cord connected to the cord connector is simply removed from the slots.

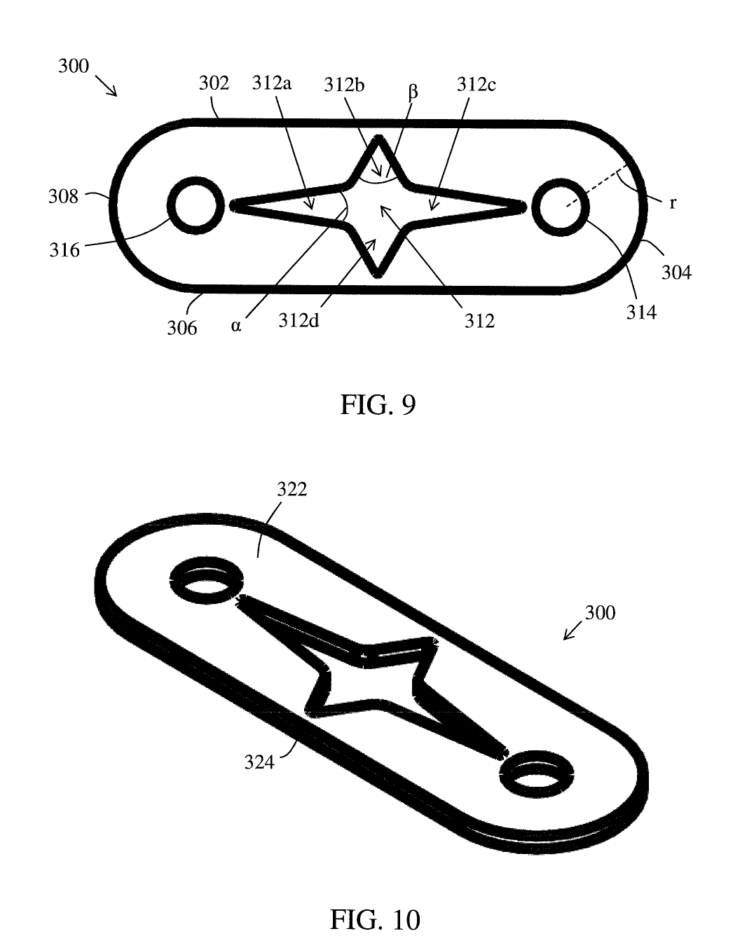

Referring now to FIGS. 9-10, there is illustrated a cord connector 300 having a generally oblong-shaped body having a top surface 322 and a bottom surface 324. The cord connector is also illustrated as having a first side edge 302, a second side edge 306, a first end edge 304, and a second end edge 308. As illustrated in FIGS. 9-10, the first and second end edges 304, 308 are curved in a continuously arcuate shape of radius r between first and second side edges 302, 306. The cord connector 300 includes a central opening 312, and first and second peripheral openings 314, 316. Peripheral opening 314 is illustrated as having a circular shape and being positioned at or near first end edge 304. Peripheral opening 316 is illustrated as having a circular shape and being positioned at or near second end edge 308. The first and second side edges are illustrated as being generally parallel to one another. The two end edges have the same shape, size and radius of curvature. The two peripheral openings are spaced from the edges of the cord connector and have the same size and shape. The thickness of the body of the cord connector is generally uniform. The body of the cord connector is formed of a durable material such as metal, wood or plastic.

Central opening 312 is illustrated as including slots 312a, 312b, 312c, 312d extending therefrom. Slots 312a, 312b, 312c, 312d generally include an open end facing the central opening 312 and a closed end extending into the body of the cord connector in a direction away from the central opening 312. As illustrated in FIGS. 9-10, central opening 312 and slots 312a, 312b, 312c, 312d are marginally continuous (i.e., no sharp edges exist between each connection); however, this is not required. The central opening and the slot form a generally star shape; however, this is not required.

With continued reference to FIGS. 9-10, slot 312a is positioned opposite slot 312c, and slot 312b is positioned opposite slot 312d about the central opening 312. Slot 312a is illustrated as extending towards end edge 308 a distance about equal to the distance slot 312c extends towards end edge 304. Similarly, slot 312b is illustrated as extending towards side edge 302 a distance about equal to the distance slot 312d extends towards side edge 306. The closed ends of slots 312a, 312b, 312c, 312d are illustrated as being substantially rounded or pointed; however, this is not required. The back end of each slot is spaced inwardly from the peripheral edge of the body.

The inner width of slots 312a, 312b, 312c, 312d are tapered such that slots 312a, 312b, 312c, 312d become increasingly narrowed towards the closed end. The back or closed ends of each of the slots are illustrated as being rounded or pointed; however, this is not required. Each of the slots are generally V-shaped. Slots 312a and 312c have generally the same size and shape. Likewise, slots 312b and 312d have generally the same size and shape The angle α formed by the two sides of each of slots 312a and 312c is illustrated as being generally the same and is about 10-40°, and more typically about 15-30°. The angle β formed by the two sides of each of slots 312b and 312d is illustrated as being generally the same and is about 15-60°, and more typically about 30-55°. Generally, the angle α formed by the two sides of each of slots 312a and 312c is less than the angle β formed by the two sides of each of slots 312b and 312d; however, this is not required. Generally, the longitudinal length of slots 312a and 312c is greater than the longitudinal length of slots 312b and 312d; however, this is not required. Generally, about 60-100% of the depth of the each slot has a tapered portion. As illustrated in FIGS. 9-10, openings 314, 316 are spaced from the edge of the body and also from the slots. The middle of opening 312 is generally positioned ±5% from the center of body of the cord connector and typically in the center of the body of the cord connector.

In use, when a single bungee cord is to be reduced in length, a portion of the bungee cord is doubled over and the looped end is pushed through the central opening in the cord connector. Thereafter, portions of the bungee cord are pushed or pulled into two oppositely positioned slots. The shape and size of the slots inhibits or prevents slippage of the bungee cord that is secured in the slots. The looped portion of the bungee cord between the two slot results in the reduced length of the bungee cord. After the use of the reduced bungee cord is completed, the portions of the bungee cord are simply removed from the slots and the bungee cord is pulled out of the central opening. When two bungee cords are to be connected together, one end of the first bungee cord is inserted through the central opening and then connected to one of the slots in the cord connector and the end of the second bungee cord is inserted through the central opening and then connected to the opposite slot from the first bungee cord thereby resulting in the connecting together of the two bungee cords. After the use of the two connected bungee cords is completed, the portions of the two bungee cords connected to the cord connector are simply removed from the slots and then pulled through the central opening.

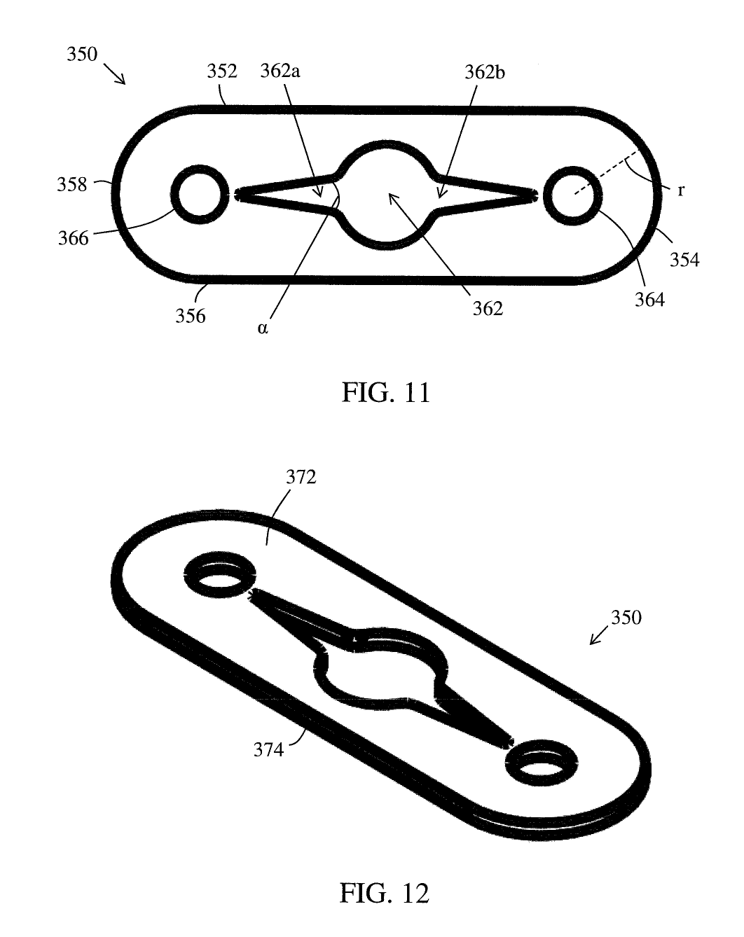

Referring now to FIGS. 11-12, there is illustrated a cord connector 350 having a generally oblong-shaped body having a top surface 372 and a bottom surface 374. The cord connector is also illustrated as having a first side edge 352, a second side edge 356, a first end edge 354, and a second end edge 358. As illustrated in FIGS. 11-12, first and second end edges 354, 358 are curved in a continuously arcuate shape of radius r between first and second end edges 352, 256. The cord connector 350 includes a central opening 362 having a generally circular shape, and a first and second peripheral opening 364, 366. Peripheral opening 364 is illustrated as having a circular shape and being positioned at or near first end edge 354. Peripheral opening 366 is illustrated as having a circular shape and being positioned at or near second end edge 358. The first and second side edges are illustrated as being generally parallel to one another. The two end edges have the same shape, size and radius of curvature. The two peripheral openings are spaced from the edges of the cord connector and have the same size and shape. The thickness of the body of the cord connector is generally uniform. The body of the cord connector is formed of a durable material such as metal, wood or plastic.

Central opening 362 is illustrated as including slots 362a, 362b extending therefrom. Slots 362a, 362b generally include an open end facing central opening 362 and a closed end extending into the body of the cord connector in a direction away from central opening 362. As illustrated in FIGS. 11-12, central opening 362 and slots 362a, 362b are marginally continuous. With continued reference to FIGS. 11-12, slot 362a is positioned opposite slot 362b. Slot 362a is illustrated as extending towards end edge 358 a distance about equal to the distance slot 362b extends towards end edge 354. The closed ends of slots 362a, 362b are illustrated as being substantially rounded or pointed; however, this is not required. The back end of each slot is spaced inwardly from the peripheral edge of the body.

With continued reference to FIGS. 11-12, slot 322a is positioned opposite slot 362b about the central opening 322. The inner width of slots 362a, 362b is tapered such that slots 362a, 362b become increasingly narrowed towards the closed end. The back or closed ends of each of the slots are illustrated as being rounded or pointed; however, this is not required. Each of the slots are generally V-shaped. Slots 362a and 362b have generally the same size and shape. The angle α formed by the two sides of each of slots 362a and 362b is illustrated as being generally the same and is about 10-40°, and more typically about 15-30°. Generally, about 60-100% of the depth of the slot has a tapered portion. As illustrated in FIGS. 11-12, openings 364, 366 are spaced from the edge of the body and also from the slots. The middle of opening 362 is generally positioned ±5% from the center of body of the cord connector and typically in the center of the body of the cord connector.

In use, when a single bungee cord is to be reduced in length, a portion of the bungee cord is doubled over and the looped end is pushed through the central opening in the cord connector. Thereafter, portions of the bungee cord are pushed or pulled into two oppositely positioned slots. The shape and size of the slots inhibits or prevents slippage of the bungee cord that is secured in the slots. The looped portion of the bungee cord between the two slot results in the reduced length of the bungee cord. After the use of the reduced bungee cord is completed, the portions of the bungee cord are simply removed from the slots and the bungee cord is pulled out of the central opening. When two bungee cords are to be connected together, one end of the first bungee cord is inserted through the central opening and then connected to one of the slots in the cord connector and the end of the second bungee cord is inserted through the central opening and then connected to the opposite slot from the first bungee cord thereby resulting in the connecting together of the two bungee cords. After the use of the two connected bungee cords is completed, the portions of the two bungee cords connected to the cord connector are simply removed from the slots and then pulled through the central opening.

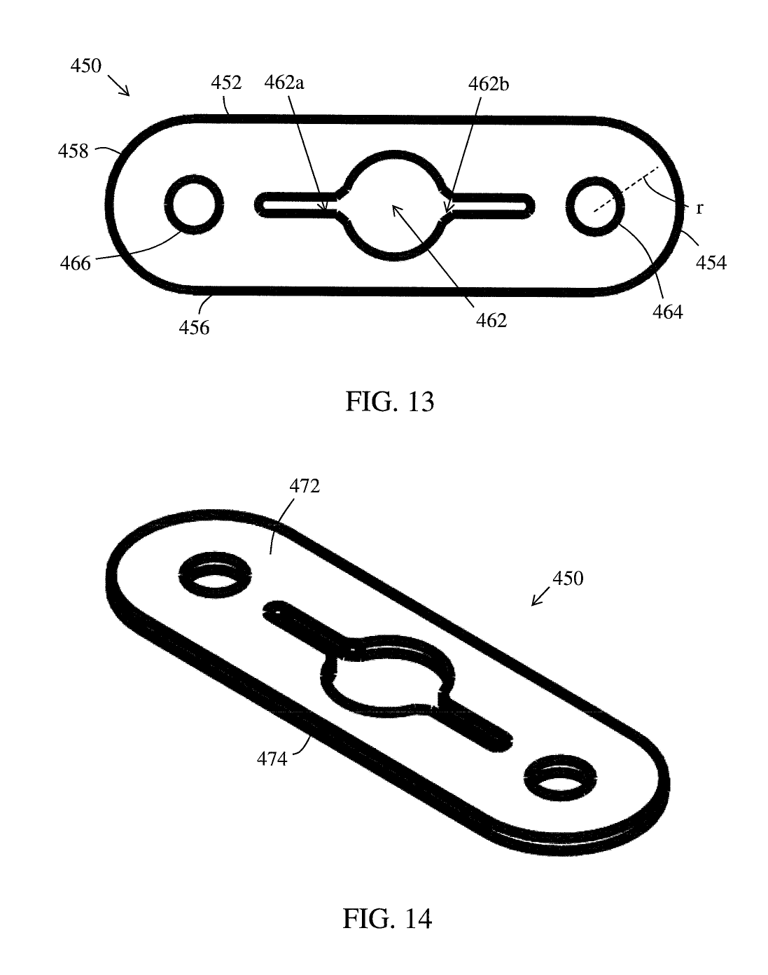

Referring now to FIGS. 13-14, there is illustrated a cord connector 450 having a generally oblong-shaped body having a top surface 472 and a bottom surface 474. The cord connector is also illustrated as having a first side edge 452, a second side edge 456, a first end edge 454, and a second end edge 458. As illustrated in FIGS. 13-14, first and second end edges 454, 458 are curved in a continuously arcuate shape of radius r between first and second end edges 452, 456. Cord connector 450 includes a central opening 462 having a generally circular shape, and first and second peripheral opening 464, 466. Peripheral opening 464 is illustrated as having a circular shape and being positioned at or near first end edge 454. Peripheral opening 466 is illustrated as having a circular shape and being positioned at or near second end edge 458. The first and second side edges are illustrated as being generally parallel to one another. The two end edges have the same shape, size and radius of curvature. The two peripheral openings are spaced from the edges of the cord connector and have the same size and shape. The thickness of the body of the cord connector is generally uniform. The body of the cord connector is formed of a durable material such as metal, wood or plastic.

Central opening 462 is illustrated as including slots 462a, 462b extending therefrom. Slots 462a, 462b generally include an open end facing the central opening 462 and a closed end extending into the body of the cord connector in a direction away from central opening 462. As illustrated in FIGS. 13-14, central opening 462 and slots 462a, 462b are marginally continuous. With continued reference to FIGS. 13-14, slot 462a is positioned opposite slot 462b. Slot 462a is illustrated as extending towards end edge 458 a distance about equal to the distance slot 462b extends towards end edge 454. The closed ends of slots 462a, 462b are illustrated as being substantially rounded so as to increase the surface area with which slots 462a, 462b are in contact with the bungee cord; however, this is not required. The back end of each slot is spaced inwardly from the peripheral edge of the body.

With continued reference to FIGS. 13-14, slot 462a is positioned opposite slot 462b about the central opening 462. The inner width of slots 462a, 462b is generally constant along the longitudinal length of the slot; however, this is not required. Slots 462a and 462b have generally the same size and shape. Since the inner width of slots 462a, 462b is constant, the slots maintain the same contact and compression force with the bungee cord as the bungee cord is pushed towards the closed end of the slots. As illustrated in FIGS. 13-14, openings 464, 466 are spaced from the edge of the body and also from the slots. The middle of opening 462 is generally positioned ±5% from the center of body of the cord connector and typically in the center of the body of the cord connector.

In use, when a single bungee cord is to be reduced in length, a portion of the bungee cord is doubled over and the looped end is pushed through the central opening in the cord connector. Thereafter, portions of the bungee cord are pushed or pulled into two oppositely positioned slots. The shape and size of the slots inhibits or prevents slippage of the bungee cord that is secured in the slots. The looped portion of the bungee cord between the two slot results in the reduced length of the bungee cord. After the use of the reduced bungee cord is completed, the portions of the bungee cord are simply removed from the slots and the bungee cord is pulled out of the central opening. When two bungee cords are to be connected together, one end of the first bungee cord is inserted through the central opening and then connected to one of the slots in the cord connector and the end of the second bungee cord is inserted through the central opening and then connected to the opposite slot from the first bungee cord thereby resulting in the connecting together of the two bungee cords. After the use of the two connected bungee cords is completed, the portions of the two bungee cords connected to the cord connector are simply removed from the slots and then pulled through the central opening.

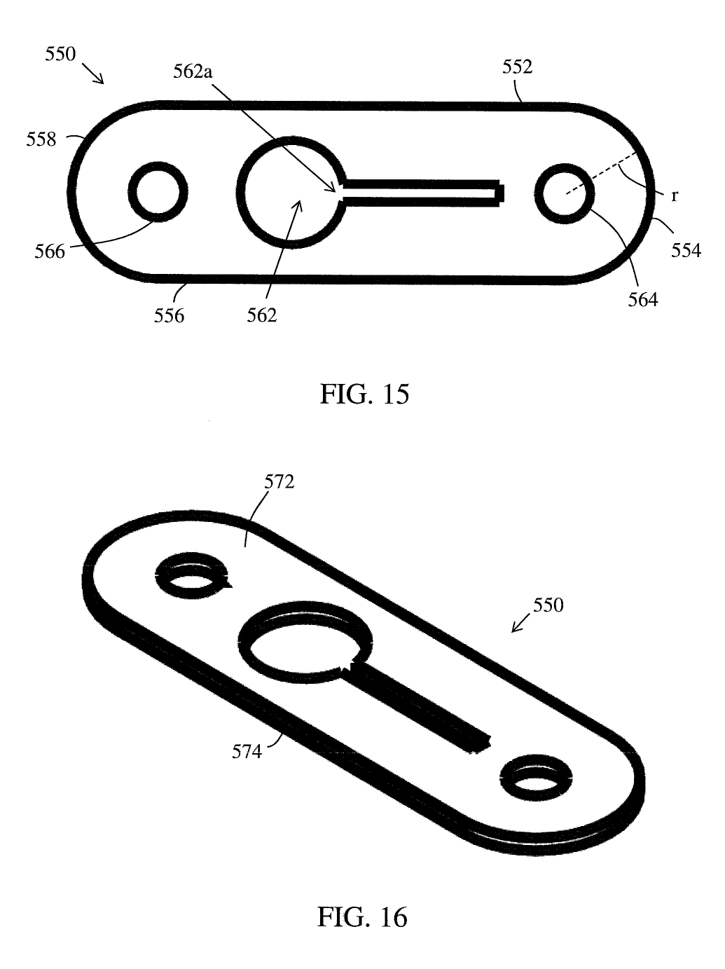

Referring now to FIGS. 15-16, there is illustrated a cord connector 550 having a generally oblong-shaped body providing a top surface 572 and a bottom surface 574. The cord connector is also illustrated as having a first side edge 552, a second side edge 556, a first end edge 554, and a second end edge 558. As illustrated in FIGS. 15-16, first and second end edges 554, 558 are curved in a continuously arcuate shape of radius r between first and second end edges 552, 556. Cord connector 550 includes a central opening 562 having a generally circular shape, and a first and second peripheral opening 564, 566. Peripheral opening 564 is illustrated as having a circular shape and being positioned at or near first end edge 554. Peripheral opening 566 is illustrated as having a circular shape and being positioned at or near second end edge 558. The first and second side edges are illustrated as being generally parallel to one another. The two end edges have the same shape, size and radius of curvature. The two peripheral openings are spaced from the edges of the cord connector and have the same size and shape. The thickness of the body of the cord connector is generally uniform. The body of the cord connector is formed of a durable material such as metal, wood or plastic.

Opening 562 is illustrated as including a slot 562a extending therefrom. Slot 562a generally includes an open end facing the central opening 562 and a closed end extending into the body of the cord connector in a direction away from central opening 562. As illustrated in FIGS. 15-16, opening 562 and slot 562a are marginally continuous. Slot 562a is illustrated as extending towards end edge 554. The closed end of slot 562a is illustrated as being substantially square; however, this is not required. As can be appreciated, the closed ends of slot 562a can be curved for the purpose of increasing the engagement between the outer circumference of the bungee cord and the closed end of slots 562a. The back end of the slot is spaced inwardly from the peripheral edge of the body.

With continued reference to FIGS. 15-16, the inner width of slot 562a is generally constant along the longitudinal length of the slot; however, this is not required. Since the inner width of slots 562a is constant, the slots maintain the same contact and compression force with the bungee cord as the bungee cord is pushed towards the closed end of the slots. As illustrated in FIGS. 15-16, openings 564, 566 are spaced from the edge of the body and also from slot 562a and opening 562. The middle of opening 562 is generally positioned off center from the center of the body of the cord connector. In one arrangement the side of opening 562 is spaced the same distance from opening 566 and the distance between the end of slot 562a and opening 564; however, this is not required.

In use, when a single bungee cord is to be reduced in length, a portion of the bungee cord is doubled over and the looped end is pushed through opening 562 in the cord connector. Thereafter, both portions of the bungee cord are pushed or pulled into slot 562a. The shape and size of the slot inhibits or prevents slippage of the bungee cord that is secured in the slot. The looped portion of the bungee cord between the two slot results in the reduced length of the bungee cord. After the use of the reduced bungee cord is completed, the portions of the bungee cord are simply removed from the slot and the bungee cord is pulled out of opening 562. When two bungee cords are to be connected together, one end of the first bungee cord is inserted through opening 562 and then inserted into slot 562a and the end of the second bungee cord is inserted through opening 562 and then also inserted into slot 562a thereby resulting in the connecting together of the two bungee cords. After the use of the two connected bungee cords is completed, the portions of the two bungee cords connected to the cord connector are simply removed from the slot and then pulled through opening 562.

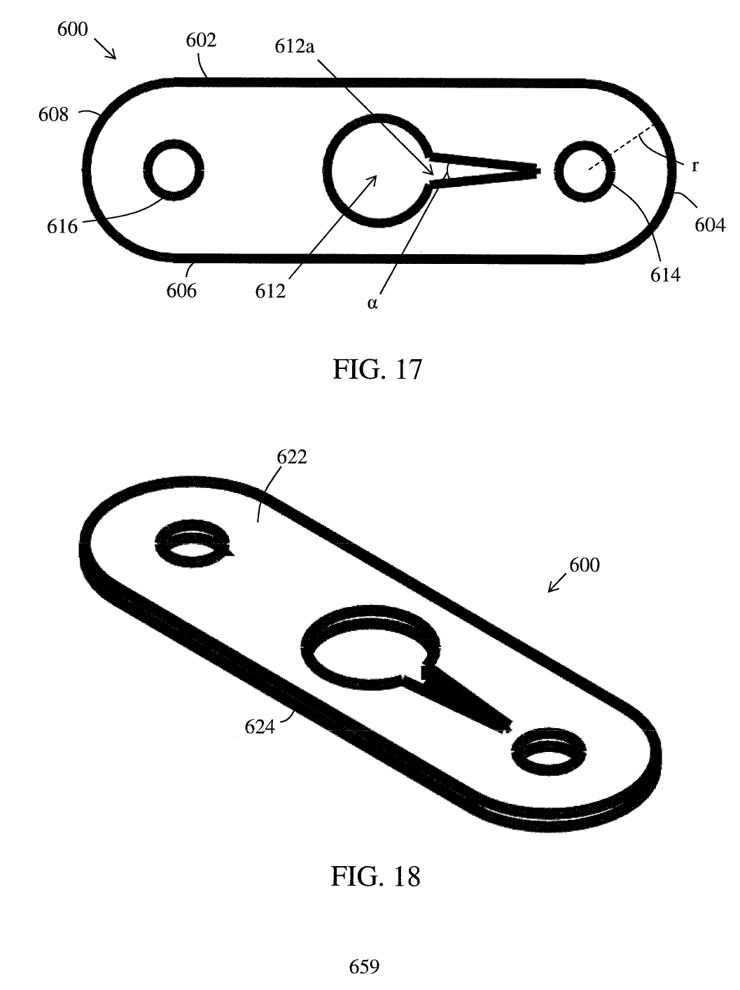

Referring now to FIGS. 17-18, there is illustrated a cord connector 600 having a generally oblong-shaped body providing a top surface 622 and a bottom surface 624. The cord connector is also illustrated as having a first side edge 602, a second side edge 606, a first end edge 604, and a second end edge 608. As illustrated in FIGS. 17-18, first and second end edges 604, 608 are curved in a continuously arcuate shape of radius r between first and second end edges 602, 606. Cord connector 600 includes central opening 612 having a generally circular shape, and first and second peripheral openings 614, 616. Peripheral opening 614 is illustrated as having a circular shape and being positioned at or near first end edge 604. Peripheral opening 616 is illustrated as having a circular shape and being positioned at or near second end edge 608. The first and second side edges are illustrated as being generally parallel to one another. The two end edges have the same shape, size and radius of curvature. The two peripheral openings are spaced from the edges of the cord connector and have the same size and shape. The thickness of the body of the cord connector is generally uniform. The body of the cord connector is formed of a durable material such as metal, wood or plastic.

Central opening 612 is illustrated as including a slot 612a extending therefrom. Slot 612a generally includes an open end facing central opening 612 and a closed end extending into the body of the cord connector in a direction away from central opening 612. As illustrated in FIGS. 17-18, central opening 612 and slot 612a are marginally continuous. Slot 612a is illustrated as extending towards end edge 604. The closed end of slot 612a is illustrated as being substantially pointed; however, this is not required. As can be appreciated, the closed ends of slot 612a can be curved for the purpose of increasing the engagement between the outer circumference of the bungee cord and the closed end of slot 612a.

The inner width of slot 612a is tapered such that slot 612a becomes increasingly narrowed towards the closed end. The back or closed ends of the slot is illustrated as being rounded or pointed; however, this is not required. Each of the slot is generally V-shaped. The angle α formed by the two sides of slot 612a is about 10-40°, and more typically about 15-30°. Generally, about 60-100% of the depth of the slot has a tapered portion. The back end of the slot is spaced inwardly from the peripheral edge of the body.

As illustrated in FIGS. 17-18, openings 614, 616 are spaced from the edge of the body and also from the central opening and slot. The middle of central opening 612 is generally positioned ±5% from the center of body of the cord connector and typically in the center of the body of the cord connector.

In use, when a single bungee cord is to be reduced in length, a portion of the bungee cord is doubled over and the looped end is pushed through central opening 612 in the cord connector. Thereafter, both portions of the bungee cord are pushed or pulled into slot 612a. The shape and size of the slot inhibits or prevents slippage of the bungee cord that is secured in the slot. The looped portion of the bungee cord between the two slot results in the reduced length of the bungee cord. After the use of the reduced bungee cord is completed, the portions of the bungee cord are simply removed from the slot and the bungee cord is pulled out of the central opening. When two bungee cords are to be connected together, one end of the first bungee cord is inserted through the central opening and then inserted into slot 612a and the end of the second bungee cord is inserted through central opening and then also inserted into slot 612a thereby resulting in the connecting together of the two bungee cords. After the use of the two connected bungee cords is completed, the portions of the two bungee cords connected to the cord connector are simply removed from the slot and then pulled through central opening.

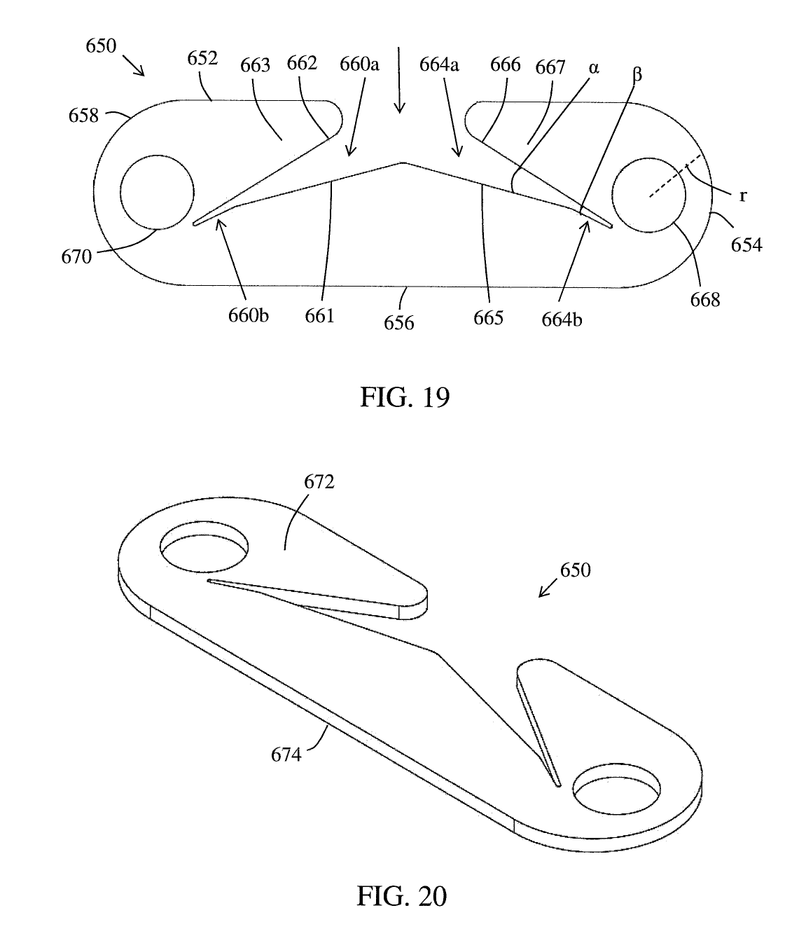

Referring now to FIGS. 19-20, there is illustrated a cord connector 650 having a generally oblong-shaped body having a top surface 672 and a bottom surface 674. The cord connector is also illustrated as having a first side edge 652, a second side edge 656, a first end edge 654, and a second end edge 658. As illustrated in FIGS. 19-20, first and second end edges 654, 656 are curved in a continuously arcuate shape of radius r between first and second side edges 652, 656. Cord connector 650 includes first and second peripheral openings 668, 670. Peripheral opening 668 is illustrated as having a circular shape and being positioned at or near first end edge 654. Peripheral opening 670 is illustrated as having a circular shape and being positioned at or near second end edge 658. The cord connector 650 also includes a central opening 659 positionable along side edge 652. The first and second side edges are illustrated as being generally parallel to one another. The two end edges have the same shape, size and radius of curvature. The two peripheral openings are spaced from the edges of the cord connector and have the same size and shape. The thickness of the body of the cord connector is generally uniform. The body of the cord connector is formed of a durable material such as metal, wood or plastic.

Cord connector 100 is illustrated in FIGS. 19-20 as including two slots 660a and 664a. The open end of slots 660a, 664a are illustrated as being provided on the same side of the cord connector such that the opening of slot 660a faces the opening of slot 664a. Slot 660a is illustrated as being positioned from edge 658 a distance about equal to the distance as slot 664a is positioned from end edge 654. The open end of slot 660a can be the same as the open end of slot 664a, thereby defining the central opening 659 along side edge 652. As such, slots 660a, 664a can extend as slots from central opening 659 on side edge 652; however, this is not required. The slots are generally V-shaped and have generally the same size and shape. The angle α formed by the two sides of each of the slot is illustrated as being generally the same and is about 10-50°, and more typically about 15-40°. The end of the each of the slots is illustrated as having the sides being generally parallel to one another; however, this is not required. Generally, about 60-100% of the depth of the each slot has a tapered portion. As illustrated in FIGS. 19-20, about 60-90% of each of the slots has a first tapered portion and the remainder a second tapered portion that is different taper angle from the first tapered portion. The angle β formed by the two sides of each of the slot in the second tapered portion is illustrated as being generally the same and is about 4-30°, and more typically about 5-15°. The back end of the slot is generally rounded; however, this is not required.

As illustrated in FIGS. 19-20, slots 660a, 664a extend in opposite directions from the central opening 659 into the body of cord connector 650 at an angle from side edge 652. In such a configuration, the closed end of slot 660a is positioned at or near peripheral opening 670, and the closed end of slot 664a is positioned at or near peripheral opening 668. Edge 661 of slot 660a is illustrated as non-parallel with side edge 656 and can slope upwardly relative to side edge 656 at an angle of about 5-25°, more typically about 10-15°; however, this is not required. The cord connector 650 is illustrated in FIGS. 19-20 as being symmetrical. As such, slot 664a can be angled from side edge 656 of cord connector 650 at a similar angle as slot 660a; however, this is not required. As can be appreciated, the angles of slots 660a and 664a relative to side edge 656 can be different. The back end of each slot is spaced inwardly from the peripheral edge of the body.

Edge 662 of slot 660a and edge 652 of the body of cord connector 650 define a hook portion 663 on the body of the cord connector. Similarly, edge 666 of slot 664a and edge 662 of the body of cord connector 650 define a hook portion 667 on the body of the cord connector. Hook portions 663, 667 are configured to facilitate insertion of a bungee cord into slots 660a, 664a, respectively. The end of hook portions 663, 667 are illustrated as being rounded for the purpose of facilitating entrance and/or exit of a bungee cord from slots 660a, 664a; however, this is not required. With continued reference to FIGS. 19-20, openings 668, 670 are spaced from slots 660a, 664a.

In use, when a single bungee cord is to be reduced in length, on portion of the bungee cord is positioned in one slot and another portion of the bungee cord is inserted into the other slot of the cord connector. The shape and size of the slots inhibits or prevents slippage of the bungee cord that is secured in the slots. The looped portion of the reduced bungee cord between the two slot results in the reduced length of the bungee cord. After the use of the bungee cord is completed, the portions of the bungee cord are simply removed from the slots. When two bungee cords are to be connected together, one portion of the first bungee cord is connected to one of the slots in the cord connector and one portion of the second bungee cord is connected to the other slot of the cord connected thereby resulting in the connecting together of the two bungee cords. After the use of the two connected bungee cords is completed, the portions of the two bungee cords connected to the cord connector are simply removed from the slots.

It will thus be seen that the objects set forth above, among those made apparent from the preceding description, are efficiently attained, and since certain changes may be made I the constructions set forth without departing from the spirit and scope of the invention, it is intended that all matter contained in the above description and shown in the accompanying drawing shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

What is claimed:

1. A cord connector configured to connect one or more cords, said cord connector comprising a body having a top surface, a bottom surface, a first end edge and a second end edge positioned opposite said first end edge, a first side edge and a second side edge positioned opposition said first side edge, said body including a cord connection arrangement configured to releaseably secure a cord to said body, said cord arrangement selected from the group consisting of a) a single cord opening positioned on said first side edge of said body and a single cord slot having a front opening in communication with said single cord opening, said single cord slot having a slot width and a longitudinal length, said single cord slot having a first and second slot sides, a majority of a longitudinal length of said first slot side is non-parallel and non-perpendicular to said second side edge of said body, a width of said single cord slot along a majority of a longitudinal length of said single cord slot is less than a width of said single cord opening, an end of said single cord slot is spaced inwardly from a peripheral edge of said body; b) a single cord opening positioned on said first side edge of said body and first and second cord slots each having a front opening in communication with said single cord opening, each of said first and second cord slots having a slot width and a longitudinal length, said first cord slot extending toward said first end edge, said second cord slot extending toward said second end edge, each of said first and second cord slots having a first and second slot sides, a majority of a longitudinal length of said first slot side of each of said first and second slot sides is non-parallel and non-perpendicular to said second side edge of said body, said width of each of said first and second cord slots along a majority of said longitudinal length of said cord slots is less than a width of said single cord opening, an end of each of said first and second cord slots is spaced inwardly from a peripheral edge of said body; c) a single cord opening spaced inwardly from said first and second end edges and said first and second side edges, a single cord slot having a front opening in communication with said single cord opening, said single cord slot having a slot width and a longitudinal length, said width of said single cord slot along a majority of said longitudinal length of said single cord slot is less than a width of said single cord opening, an end of said single cord slot is spaced inwardly from a peripheral edge of said body; d) a single cord opening spaced inwardly from said first and second end edges and said first and second side edges, a first and second cord slot each having a front opening in communication with said single cord opening, said first and second cord slots each having a slot width and a longitudinal length, said width of each of said first and second cord slots along a majority of said longitudinal length of said cord slots is less than a width of said single cord opening, an end of each of said first and second cord slots is spaced inwardly from a peripheral edge of said body, said first cord slot extending toward said first end edge, said second cord slot extending toward said second end edge; or e) a first cord opening positioned on said first side edge of said body and a first cord slot having a front opening in communication with said first cord opening, a second cord opening positioned on said second side edge of said body and a second cord slot having a front opening in communication with said second cord opening, each of said first and second cord slots having a slot width and a longitudinal length, each of said first and second cord slots having a first and second slot sides, a majority of a longitudinal length of said first slot side of each of said first and second cord slots is non-parallel and non-perpendicular to said first and second side edges of said body, an end of each of said first and second cord slots is spaced inwardly from a peripheral edge of said body.

2. The cord connector as defined in claim 1, wherein said width of at least one of said of said cord slots varies along a majority of said longitudinal length of said cord slot.

3. The cord connector as defined in claim 1, wherein at least one of said of said cord slots has a V-shaped profile.

4. The cord connector as defined in claim 2, wherein at least one of said of said cord slots has a V-shaped profile.

5. The cord connector as defined in claim 1, including a body opening, said body opening spaced from said cord opening and said cord slot, said body opening spaced inwardly from said peripheral edge of said body.

6. The cord connector as defined in claim 4, including a body opening, said body opening spaced from said cord opening and said cord slot, said body opening spaced inwardly from said peripheral edge of said body.

7. The cord connector as defined in claim 1, wherein said body includes said single cord opening positioned on said first side edge of said body and said single cord slot having said front opening in communication with said single cord opening, at least 60% of said longitudinal length of said first slot side is non-parallel and non-perpendicular to said second side edge of said body, said single cord slot having a V-shaped profile or a U-shaped profile.

8. The cord connector as defined in claim 5, wherein said body includes said single cord opening positioned on said first side edge of said body and said single cord slot having said front opening in communication with said single cord opening, at least 60% of said longitudinal length of said first slot side is non-parallel and non-perpendicular to said second side edge of said body, said single cord slot having a V-shaped profile or a U-shaped profile.

9. The cord connector as defined in claim 1, wherein said body includes said single cord opening positioned on said first side edge of said body and said first and second cord slots each having said front opening in communication with said single cord opening, said first cord slot extending toward said first end edge, said second cord slot extending toward said second end edge, at least 60% of said longitudinal length of said first slot side of each of said first and second slot sides is non-parallel and non-perpendicular to said second side edge of said body, each of said first and second cord slots having a V-shaped profile or a U-shaped profile.

10. The cord connector as defined in claim 5, wherein said body include said single cord opening positioned on said first side edge of said body and said first and second cord slots that having said front opening in communication with said single cord opening, said first cord slot extending toward said first end edge, said second cord slot extending toward said second end edge, at least 60% of said longitudinal length of said first slot side of each of said first and second slot sides is non-parallel and non-perpendicular to said second side edge of said body, each of said first and second cord slots having a V-shaped profile or a U-shaped profile.

11. The cord connector as defined in claim 1, wherein said body includes said single cord opening spaced inwardly from said first and second end edges and said first and second side edges, said single cord slot having said front opening in communication with said single cord opening, said width of said single cord slot along at least 60% of said longitudinal length of said single cord slot is less than a width of said single cord opening, said single cord slot having a V-shaped profile or a U-shaped profile.

12. The cord connector as defined in claim 5, wherein said body includes said single cord opening spaced inwardly from said first and second end edges and said first and second side edges, said single cord slot having said front opening in communication with said single cord opening, said width of said single cord slot along at least 60% of said longitudinal length of said single cord slot is less than a width of said single cord opening, said single cord slot having a V-shaped profile or a U-shaped profile.

13. The cord connector as defined in claim 1, wherein said body includes said single cord opening spaced inwardly from said first and second end edges and said first and second side edges, said first and second cord slots each having said front opening in communication with said single cord opening, said width of each of said first and second cord slots along at least 60% of said longitudinal length of said cord slots is less than said width of said single cord opening, said first cord slot extending toward said first end edge, said second cord slot extending toward said second end edge, each of said first and second cord slots having a V-shaped profile or a U-shaped profile.

14. The cord connector as defined in claim 5, wherein said body includes said single cord opening spaced inwardly from said first and second end edges and said first and second side edges, said first and second cord slots each having said front opening in communication with said single cord opening, said width of each of said first and second cord slots along at least 60% of said longitudinal length of said cord slots is less than said width of said single cord opening, said first cord slot extending toward said first end edge, said second cord slot extending toward said second end edge, each of said first and second cord slots having a V-shaped profile or a U-shaped profile.

15. The cord connector as defined in claim 1, wherein said body includes said first cord opening positioned on said first side edge of said body and said first cord slot having a front opening in communication with said first cord opening, said second cord opening positioned on said second side edge of said body and said second cord slot having a front opening in communication with said second cord opening, each of said first and second cord slots having a first and second slot sides, at least 60% of a longitudinal length of said first slot side of each of said first and second cord slots is non-parallel and non-perpendicular to said first and second side edges of said body, each of said first and second cord slots having a V-shaped profile or a U-shaped profile.

16. The cord connector as defined in claim 1, wherein said body is oblong shaped, said first and second end edges are arcuate shaped, a majority of a longitudinal length of said first and second side edges are parallel to one another.

17. The cord connector as defined in claim 1, wherein edges of said cord opening are rounded.

18. A method for releasably connecting a cord to a cord connector comprising:
a. providing a cord;
b. providing said cord connector, said cord connector comprising a body having a top surface, a bottom surface, a first end edge and a second end edge positioned opposite said first end edge, a first side edge and a second side edge positioned opposition said first side edge, said body including a cord connection arrangement configured to releaseably secure a cord to said body, said cord arrangement selected from the group consisting of a) a single cord opening positioned on said first side edge of said body and a single cord slot having a front opening in communication with said single cord opening, said single cord slot having a slot width and a longitudinal length, said single cord slot having a first and second slot sides, a majority of a longitudinal length of said first slot side is non-parallel and non-perpendicular to said second side edge of said body, a width of said single cord slot along a majority of a longitudinal length of said single cord slot is less than a width of said single cord opening, an end of said single cord slot is spaced inwardly from a peripheral edge of said body; b) a single cord opening positioned on said first side edge of said body and first and second cord slots each having a front opening in communication with said single cord opening, each of said first and second cord slots having a slot width and a longitudinal length, said first cord slot extending toward said first end edge, said second cord slot extending toward said second end edge, each of said first and second cord slots having a first and second slot sides, a majority of a longitudinal length of said first slot side of each of said first and second slot sides is non-parallel and non-perpendicular to said second side edge of said body, said width of each of said first and second cord slots along a majority of said longitudinal length of said cord slots is less than a width of said single cord opening, an end of each of said first and second cord slots is spaced inwardly from a peripheral edge of said body; c) a single cord opening spaced inwardly from said first and second end edges and said first and second side edges, a single cord slot having a front opening in communication with said single cord opening, said single cord slot having a slot width and a longitudinal length, said width of said single cord slot along a majority of said longitudinal length of said single cord slot is less than a width of said single cord opening, an end of said single cord slot is spaced inwardly from a peripheral edge of said body; d) a single cord opening spaced inwardly from said first and second end edges and said first and second side edges, first and second cord slots having a front opening in communication with said single cord opening, said first and second cord slots each having a slot width and a longitudinal length, said width of each of said first and second cord slots along a majority of said longitudinal length of said cord slots is less than a width of said single cord opening, an end of each of said first and second cord slots is spaced inwardly from a peripheral edge of said body, said first cord slot extending toward said first end edge, said second cord slot extending toward said second end edge; or e) a first cord opening positioned on said first side edge of said body and a first cord slot having a front opening in communication with said first cord opening, a second cord opening positioned on said second side edge of said body and a second cord slot having a front opening in communication with said second cord opening, each of said first and second cord slots having a slot width and a longitudinal length, each of said first and second cord slots having a first and second slot sides, a majority of a longitudinal length of said first slot side of each of said first and second cord slots is non-parallel and non-perpendicular to said first and second side edges of said body, an end of each of said first and second cord slots is spaced inwardly from a peripheral edge of said body; and,
c. releasably connecting a portion of said cord to at least one of said cord slots.
